(19) United States
(12) Patent Application Publication
(10) Pub. No.: US 2023/0090080 A1
(43) Pub. Date: Mar. 23, 2023

(54) METHOD AND APPARATUS FOR FULL COVERAGE PATH PLANNING OVER THREE-DIMENSIONAL TERRAIN

(71) Applicants: Topcon Positioning Systems, Livermore, CA (US); The Skolkovo Institute of Science and Technology, Moscow (RU)

(72) Inventors: Lev Borisovich RAPOPORT, Moscow (RU); Timofey TORMAGOV, Moscow (RU); Ivan Giovanni DI FEDERICO, Argenta (IT)

(73) Assignees: Topcon Positioning Systems, Inc., Livermore, CA (US); The Skolkovo Institute of Science and Technology, Moscow (RU)

(21) Appl. No.: 17/755,222

(22) PCT Filed: Sep. 23, 2021
(86) PCT No.: PCT/RU2021/000410

§ 371 Date: Apr. 23, 2022

(51) Int. Cl. G01C 21/20; A01B 69/04; G05D 1/02

(52) U.S. Cl. CPC G01C 21/20; A01B 69/008; G05D 1/0212; G05D 2201/0201

(57) ABSTRACT

A method for path planning for a machine to traverse an area includes calculating a spline trajectory based on a plurality of control points of a first path. A subset of the plurality of control points having an equal step is selected. A direction of the normal to the spline trajectory for each of the selected points is determined. Control points within the subset that are a solution to a second order cone programming class optimization problem along each normal to the spline trajectory are searched for and the spline trajectory is extended to a border of the area to create a second path adjacent to the first path based on the control points. The optimization problem can minimize the weighted sum of the average curvature at junction points of elementary sections of the spline trajectory and/or the average width overlap of adjacent paths.

### FIELD OF THE DISCLOSURE

The present disclosure relates generally to automatic control of machines and, more particularly, to full coverage path planning over three-dimensional terrain.

### BACKGROUND

Automation of machines, such as agricultural machines, can provide benefits that can improve crop yield and increase efficiency of crop processing. For example, automation of fertilizer spreaders can improve the speed and accuracy of fertilizer application. Automation of a machine requires data to control operation of the machine, see for example “Automatic guidance of a farm tractor relying on a single CP-DGPS” by Thuilot, B., Cariou, C., Martinet, P., and Berducat, M., in Autonomous Robots, 2002, no. 1, p. 53-71. Determining a path that a machine should follow for a particular operation requires planning that takes into account multiple factors such as machine capabilities. For example, a machine using an Ackermann steering mechanism with a constrained maximum steering angle can lead to unprocessed areas of a field due to geometric infeasibility of strict parallel paths. Machine and path planning limitations can also result in an undesirable amount of overlap of paths. What is needed is a method for path planning for a machine that takes into account multiple factors that affect efficient operation of the machine.

### SUMMARY

The present disclosure pertains to path planning for a machine to traverse an area (e.g., a field). In one embodiment, a spline trajectory based on a plurality of control points of a first path is calculated. A subset of the plurality of control points having an equal step is selected. The equal step can be based on a Euclidian metric (see, for example, “The Theory of Matrices”, 2nd edition, by Lancaster, P and Tismenetsky, M. Academic Press 1985). A direction of the normal to the spline trajectory for each of the selected points is determined. Control points within the subset that are a solution to a second order cone programming class optimization problem along each normal to the spline trajectory are searched for and the spline trajectory is extended to a border of the field to create a second path adjacent to the first path based on the control points. The optimization problem can minimize the average curvature at junction points of elementary sections of the spline trajectory and/or can minimize the average width overlap of adjacent paths. The optimization problem comprises an upper bound of a curvature constraint that can be based on a maximum steering angle of a machine to follow a planned path. The first path can be identified by an azimuth and a point in the area. The first path can be a section of an area boundary of the field. An apparatus and computer readable medium for path planning are also described.

### BRIEF DESCRIPTION OF THE DRAWINGS

FIG. 1 shows a machine traversing a field along a planned path;

FIG. 2 shows a plane containing a vector orthogonal to axis z;

FIG. 3 shows equidistant points of an original spline used as starting points used to determine control points of a next spline according to an embodiment;

FIG. 4 shows an application of the triangle inequality theorem as used in path planning according to an embodiment;

FIG. 5 shows a chart illustrating a rate of straightening of trajectories when passing from row to row;

FIG. 6 a method for full coverage path planning according to an embodiment; and

FIG. 7 shows a high-level block diagram of a computer for implementing a method according to an embodiment.

### DETAILED DESCRIPTION

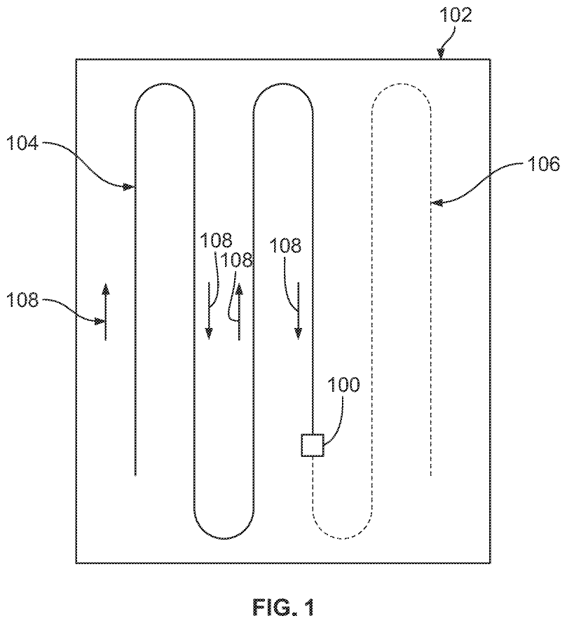

FIG. 1 shows machine 100 traversing field 102 in alternating directions shown by arrows 108. Machine 100 is shown having already travelled path portion 104. Machine 100 has not yet travelled along path portion 106. Machine 100 can be performing one or more functions as it traverses field 102. For example, machine 100 can be applying fertilizer, seed, pesticide, etc. Machine 100 can alternatively be harvesting grain or otherwise processing a crop grown in field 102. In one embodiment, path portions 104 and 106 are part of a planned path for ensuring coverage of the field without gaps while minimizing the area of overlapping sections. In one embodiment, machine 100 has an Ackermann steering mechanism with a constrained maximum steering angle (e.g., rotation angle of steering wheels). A method described below is used to determine the planned path of machine 100.

In one embodiment, the Boustrophedon method is used to process field 102 (i.e., traversing field 102 in a back-and-forth manner). Field 102 is divided into parallel swaths each of which are further processed. A pre-selected section of a field boundary is used as the starting path (i.e., a seed path for use by an algorithm) to minimize the number of turning points. There is a large amount of literature on this subject. For example, see “On complete coverage path planning algorithms for non-holonomic mobile robots: Survey and Challenges” by Khan, I. Noreen, and Z. Habib in Journal of Information Science and Engineering, 2017, no. 1, pp. 101-121; “Region filling operations with random obstacle avoidance for mobile robots” by Z. L. Cao, Y. Huang, and E. L. Hall in Journal of Robotic systems, 1988, no. 2, pp. 87-102; “Driving angle and track sequence optimization for operational path planning using genetic algorithms” by Hameed, I. A., Bochtis, D., and Sorensen, C. in Applied Engineering in Agriculture, 2011, no. 6, pp. 1077-1086; “Coverage path planning algorithms for agricultural field machines,” by Oksanen, T., and Visala, A. in Journal of field robotics, 2009, no. 8, pp. 651-668; “Side-to-side 3d coverage path planning approach for agricultural robots to minimize skip/overlap areas between swaths” by Hameed, I. A., la Cour-Harbo, A., and Osen, O. L. in Robotics and Autonomous Systems, 2016, vol. 76, pp. 36-45; “Coverage path planning on three-dimensional terrain for arable farming” by Jin, J., and Tang, L. in Journal of field robotics, 2011, no. 3, pp. 424-440; “Automated generation of guidance lines for operational field planning” by Hameed, I., Bochtis, D., Sørensen, C., and Nøremark, M. in Biosystems engineering, 2010, no. 4, pp. 294-306; “Farmwork path planning for field coverage with minimum overlapping” by Fabre, S., Soures, P., Taix, M., and Cordesses, L. in 8th International Conference on Emerging Technologies and Factory Automation (ETFA), 2001, vol. 2, pp. 691-694; “Simulation study on coverage path planning of autonomous tasks in hilly farmland based on energy consumption model” by Shen, M., Wang, S., Wang, S., and Su, Y. in Mathematical Problems in Engineering, Hindawi, vol. 2020; and “Intelligent coverage path planning for agricultural robots and autonomous machines on three-dimensional terrain” by Hameed, I. A. in Journal of Intelligent and Robotic Systems, 2014, no. 3-4, pp. 965-983. Different heuristic algorithms are proposed to cover the field by equidistant paths, though there is a lack of strict problem settings and computationally efficient algorithms. The path is approximated using basis splines (“B-splines”), for which the first and second derivatives are continuous. The spline trajectory is represented by a set of elementary sections, each of which is constructed from four control points and lies in their convex hull.

The constrained maximum steering angle of machine 100 due to the Ackermann steering mechanism leads to a constraint on the maximum allowable curvature of the trajectory when planning paths. This can lead to unprocessed areas of the field due to geometric infeasibility of strict parallel paths.

In one embodiment, a path planning method consists of exclusion of unprocessed areas due to the constrained overlap of adjacent tracks (for example, 5-20% of the initial width). The exact value of the minimum overlap percentage can be determined iteratively. This will be the first value for which the constructing a parallel path results in the feasible solution). The method is reduced to solving an optimization problem of the Second Order Cone Programming (SOCP) class, in which the weighted sum of the average curvature at the junction points of the elementary sections of the splines and/or the average width of the overlap of adjacent tracks is minimized, while the values of the overlap and the curvature are constrained. As a result, due to the overlap, the paths are straightened, and the curvature constraint is satisfied.

Paths adjacent to the starting path are determined using an algorithm. In one embodiment, an adjacent path scheduling algorithm is as follows: A spline trajectory is constructed from control points of an original path, and then points are selected on the trajectory with an equal step in a Euclidean metric. For these points, the directions of the normal to the spline path are determined. Along the calculated normal directions, a search is made for points that are a solution to an optimization problem. The trajectories are extended to the border of a field (e.g., field 102). The obtained solution to the optimization problem is used as a set of control points for the next path. In one embodiment, the upper bound of the curvature constraint is taken into account when solving the optimization problem. Curvature constraints are expressed in the form of the second order cone constraints which casts the optimization problem into the SOCP class. This makes the problem numerically tractable as SOCP is convex, see “Lectures on Modern Convex Optimization: Analysis, Algorithms, and Engineering Applications” by Ben-Tal, A. and Nemirovski, A. in MOS-SIAM Series on Optimization, 2001, for additional information about convex optimization. There are freeware (for example, CVX, as described on the CVX Research website) and commercial packages (for example, GUROBI, as described on the Gurobi Optimization website) available for efficient solution of convex optimization problems.

In one embodiment, the terrain of field 102 is modeled as follows. A local coordinate system East North Up (“ENU”) is used, with the origin of coordinates being referenced to one of the points of field 102, the axis z (U) is directed upwards, and axes x and y correspond to east and north.

A digital elevation model (“DEM”) using the ENU coordinate system is defined by a set of control points in three-dimensional space, which are obtained by measurements, and the function z(x, y), which allows determination of the height of a point not contained in the measurement set by its coordinates in the X-Y plane. For construction of z(x, y) 2D B-spline interpolation is used. The spline coefficients are calculated once based on a set of control points, and then are used whenever determination of a height of a point needs to be determined.

To approximate the path, uniform cubic B-splines are used, which are first constructed in the X-Y plane, and then projected onto the surface using a function. Each path consists of elementary B-splines, and the first and second derivatives of the path are continuous in the spline joining currents. Each elementary B-spline is constructed using four control points rᵢ₋₁, rᵢ, rᵢ₊₁, rᵢ₊₂ ∈ R² the following way:

$${r}^{( i )} ( t ) = {b}_{0} ( t ) {r}_{i - 1} + {b}_{1} ( t ) {r}_{i} + {b}_{2} ( t ) {r}_{i + 1} + {b}_{3} ( t ) {r}_{i + 2}$$

$${b}_{0} ( t ) = \frac{{( 1 - t )}^{3}}{6} , {b}_{1} ( t ) = \frac{4 - 6 {t}^{2} + 3 {t}^{3}}{6} , {b}_{2} ( t ) = \frac{1 + 3 t + 3 {t}^{2} - 3 {t}^{3}}{6} , {b}_{3} ( t ) = \frac{{t}^{3}}{6} ,$$

where t is a spline parameter, 0≤t≤1. Thus, the target trajectory is given by a set of control points r₁, r₂, . . . , rₙ, where each four consecutive points defines an elementary segment of the trajectory. The set of control points of the trajectory must be supplemented with additional points r₋₁, r₀, rₙ₊₁, rₙ₊₂, for example:

r₋₁=3r₁−2r₂,r₀=2r₁−r₂,rₙ₊₁=2rₙ−rₙ₋₁,rₙ₊₂=3rₙ−2rₙ₋₁

In this case, the set of control points is complemented so that the last and first four points lie on a straight line. The start and end of the spline path will match the first and last original control points (r₁ and rₙ). This is due to the fact that the convex hull of the first and last four control points degenerates into a segment.

Calculation of the derivative with respect to the spline parameter determines the direction of the tangent to it

$${r}^{{( i )}^{′}} ( t ) = {b}_{0}^{′} ( t ) {r}_{i - 1} + {b}_{1}^{′} ( t ) {r}_{i} + {b}_{2}^{′} ( t ) {r}_{i + 1} + {b}_{3}^{′} ( t ) {r}_{i + 2}$$

$${b}_{0}^{′} ( t ) = \frac{- 3 {( 1 - t )}^{2}}{6} = \frac{- {( 1 - t )}^{2}}{2} , {b}_{1}^{′} ( t ) = \frac{- 12 t + 9 {t}^{2}}{6} = - 2 t + 1.5 {t}^{2} , {b}_{2}^{′} ( t ) = \frac{3 + 6 t - 9 {t}^{2}}{6} = 0.5 + t - 1.5 {t}^{2} , {b}_{3}^{′} ( t ) = \frac{3 {t}^{2}}{6} = \frac{{t}^{2}}{2} .$$

Unlike natural parametrization for B-splines, the length of the first derivative vector may differ from one, but the direction also coincides with the tangent. Accordingly, the direction of the normal to the projection of the trajectory (in the X-Y plane) is determined by the rotation of the tangent vector r⁽ⁱ⁾′(t) to ±π/2.

Second derivative with respect to the parameter is:

r⁽ⁱ⁾^{ⁿ}(t)=b₀ⁿ(t)rᵢ₋₁+b₁ⁿ(t)rᵢ+b₂ⁿ(t)rᵢ₊₁b₃ⁿ(t)rᵢ₊₂

b₀ⁿ(t)=1−t,b₁ⁿ(t)=3t−2,

b₂ⁿ(t)=1−3t,b₃ⁿ(t)=t.

Due to the spline being parameterized not by the length, but by the spline parameter t, 0≤t≤1 the angle between vectors r⁽ⁱ⁾′(t) and r⁽ⁱ⁾^{ⁿ}(t) may differ of right one.

Curvature of the path at a point r⁽ⁱ⁾(t) ∈R² is defined as

$${k}^{( i )} ( t ) = \frac{‖ {r}^{{( i )}^{′}} ( t ) ⨯ {r}^{{( i )}^{″}} ( t ) ‖}{{‖ {r}^{{( i )}^{′}} ( t ) ‖}^{3}} = \frac{‖ {r}^{{( i )}^{″}} ( t ) ‖ sin φ ( t )}{{‖ {r}^{{( i )}^{′}} ( t ) ‖}^{2}} ,$$

using a cross product, the norm of vectors is Euclidean, φ(t)−acute (or right) angle between vectors r⁽ⁱ⁾′(t) and r⁽ⁱ⁾^{ⁿ}(t).

Since the target vehicle has the Ackermann steering mechanism, the constrained angle of steering wheels, assumes the constraint on the curvature of the path: k⁽ⁱ⁾(t)≤kₘₐₓ∀i=1, . . . ,n.

In one embodiment, a starting path in the form of a straight line can be determined by a point in field 102 and an azimuth. In this embodiment, further adjacent paths are constructed on the left and right sides of the initial one. In order to optimize the number of turns, a section of the field boundary can be used as the starting path. In this scenario, only one adjacent path is planned further, by only one side of the initial one.

In one embodiment, the parallel path planning problem is formulated as follows. Given some initial path, at approximately equidistant points are set on it r₁, r₂, . . . , rₙ ∈R³ (e.g., the path was resampled). These points are projections of the spline path in the X-Y plane onto an uneven surface. In one embodiment, it is required in three-dimensional space to find the control points of a neighboring path for which the curvature constraint would be satisfied. In this case, the width of the track cannot exceed the specified distance d̅. In this case, the overlap of paths is allowed for 100×(1−α) %. In other words, for example, an 20% overlap corresponds to α=0.8 and omissions are not allowed. For every point rᵢ, the normal to the projection onto the X-Y plane of the spline curve is determined. This vector can be denoted by (Nᵢ^{x},Nᵢ^{y}). In one embodiment, its length is exactly d̅. The direction that corresponds to the construction of the adjacent path is selected among the two directions of the normal. In one embodiment, the projection Nᵢ^{z} is defined as follows:

Nᵢ^{z}=z(xᵢ+Nᵢ^{x},yᵢ+Nᵢ^{y})−z(xᵢ,yᵢ).

In one embodiment, the three-dimensional vectors Nᵢ=(Nᵢ^{x},Nᵢ^{y},Nᵢ^{z}) will also be considered. The following simplifying assumption can be taken: the piece of surface in the ∥Nᵢ∥− neighborhood around the current point is sufficiently precise treated as a plane. Hereinafter, it will be assumed that all norms of vectors are Euclidean. The control point of the new spline will be rᵢ+dᵢNᵢ, where dᵢ>0. The swath width constraints are:

αd̅≤dᵢ∥Nᵢ∥≤d̅ where i=1,2, . . . ,n.

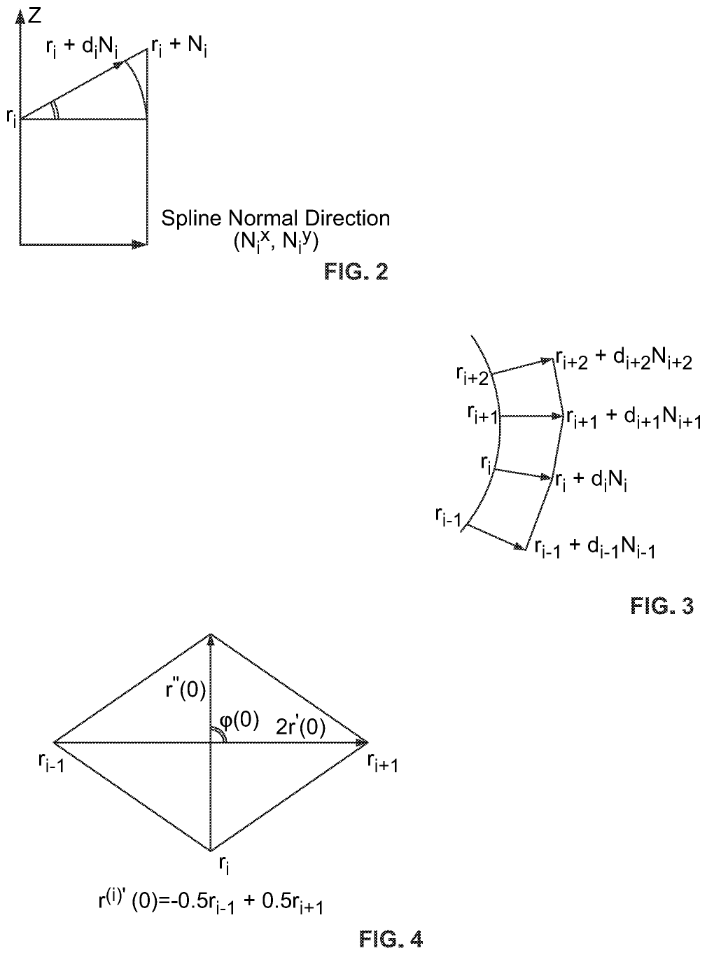

Referring to FIG. 2, the plane containing the vector Nᵢ=(Nᵢ^{x},Nᵢ^{y},Nᵢ^{z}) and the axis z orthogonal to it is considered. In one embodiment, it is required to find a vector rᵢ+dᵢNᵢ collinear to rᵢ+Nᵢ. If there were no constraints on the curvature of the trajectory, then the length of this vector would be equal to d̅. When constrained on curvature, the length of this vector will be different.

Referring to FIG. 3, each elementary section of the new spline is determined. In one embodiment, the equidistant points of the original spline are used as the starting point rᵢ₋₁, rᵢ, rᵢ₊₁, rᵢ₊₂, ∈ R³. The control points of the next spline rᵢ₋₁+dᵢ₋₁Nᵢ₋₁, rᵢ+dᵢNᵢ, rᵢ₊₁+dᵢ₊₁Nᵢ₊₁, rᵢ₊₂+dᵢ₊₂Nᵢ₊₂ are then determined accordingly.

In one embodiment, the optimization problem of finding a neighboring path is determined as follows. For simplicity, constraints on the curvature of a flat trajectory will be applied, i.e. for B-splines in the X-Y plane. Proof for the following statement is provided below.

Statement 1. The maximum value of the norm of the second derivative vector with respect to the spline parameter ∥r⁽ⁱ⁾^{ⁿ}(t)∥ for the elementary segment of a B-spline, is achieved at the boundary (for t=0 or t=1).

### Proof

r⁽ⁱ⁾^{ⁿ}(t)=(1−t)rᵢ₋₁+(3t−2)rᵢ+(1−3t)rᵢ₊₁+(t)rᵢ₊₂=(rᵢ₋₁−2rᵢ+rᵢ₊₁)+t(−rᵢ₋₁−2rᵢ+rᵢ₊₁+rᵢ₊₂)

### Let

$${r}_{i} = ( \begin{matrix}{x}_{i} \\ {y}_{i}\end{matrix} )$$

$$A = {x}_{i - 1} - 2 {x}_{i} + {x}_{i + 1} B = - {x}_{i - 1} - 2 {x}_{i} + {x}_{i + 1} + {x}_{i + 2}$$

$$C = {y}_{i - 1} - 2 {y}_{i} + {y}_{i + 1} , D = - {y}_{i - 1} - 2 {y}_{i} + {y}_{i + 1} + {y}_{i + 2} ,$$

$${‖ {r}^{{( i )}^{″}} ( t ) ‖}^{2} = {A}^{2} + 2 tAB + {t}^{2} {B}^{2} + {C}^{2} + 2 tCD + {t}^{2} {D}^{2} = {t}^{2} ( {B}^{2} + {D}^{2} ) + 2 t ( AB + CD ) + {A}^{2} + {B}^{2} .$$

Dependency ∥r⁽ⁱ⁾^{ⁿ}(t)∥² on the spline parameter t is either a straight line or a convex parabola. So, maximum value of ∥r⁽ⁱ⁾^{ⁿ}(t)∥ is achieved at t=0 or t=1. Proof of which is explained herein.

Curvature of the elementary segment is

$${k}^{( i )} ( t ) = \frac{‖ {r}^{{( i )}^{″}} ( t ) ‖ sin φ ( t )}{{‖ {r}^{{( i )}^{′}} ( t ) ‖}^{2}} .$$

The curvature constraint must be satisfied at all points of the new path. Its upper bound \hat{k}⁽ⁱ⁾(t)≥k⁽ⁱ⁾(t) is

$${\hat{k}}^{( i )} ( t ) = \frac{‖ {r}^{{( i )}^{″}} ( t ) ‖}{{‖ {r}^{{( i )}^{′}} ( t ) ‖}^{2}} .$$

Further, assume that ∥r⁽ⁱ⁾′(t)∥ is slowly varying with an approximately equidistant location of control points. This allows ∥r⁽ⁱ⁾′(t)∥ to be consider approximately constant on each elementary spline. Based on this, the constraint on the estimate of the curvature is required only at the connection points of the elementary sections of the splines:

$${\hat{k}}^{〈 i )} ( 0 ) \leq {k}_{max} , i = 1 , 2 , … , n .$$

$${r}^{{( i )}^{′}} ( 0 ) = - 0.5 {r}_{i - 1} + 0.5 {r}_{i + 1} .$$

$${r}^{{( i )}^{″}} ( 0 ) = {r}_{i - 1} - 2 {r}_{i} + {r}_{i + 1} .$$

$$‖ \begin{matrix}{x}_{i - 1} + {N}_{i - 1}^{x} {d}_{i - 1} - 2 ( {x}_{i} + {N}_{i}^{x} {d}_{i} ) + {x}_{i + 1} + {N}_{i + 1}^{x} {d}_{i + 1} \\ {y}_{i - 1} + {N}_{i - 1}^{y} {d}_{i - 1} - 2 ( {y}_{i} + {N}_{i}^{y} {d}_{i} ) + {y}_{i + 1} + {N}_{i + 1}^{y} {d}_{i + 1}\end{matrix} ‖ \leq {k}_{max} {‖ {r}^{{( i )}^{′}} ( 0 ) ‖}^{2}$$

For uniformly distributed control points dₛ=∥rᵢ−rᵢ₊₁∥=∥rᵢ−rᵢ₊₂∥

FIG. 4 shows an application of the triangle inequality theorem as used in path planning according to an embodiment. The triangle inequality provides that:

∥rᵢ₊₁−rᵢ₋₁∥≤2dₛ

∥r⁽ⁱ⁾′(0)∥²=∥−0.5rᵢ₋₁+0.5rᵢ₊₁∥≤dₛ

The condition below follows from the inequality:

$$‖ \begin{matrix}{x}_{i - 1} + {N}_{i - 1}^{x} {d}_{i - 1} - 2 ( {x}_{i} + {N}_{i}^{x} {d}_{i} ) + {x}_{i + 1} + {N}_{i + 1}^{x} {d}_{i + 1} \\ {y}_{i - 1} + {N}_{i - 1}^{y} {d}_{i - 1} - 2 ( {y}_{i} + {N}_{i}^{y} {d}_{i} ) + {y}_{i + 1} + {N}_{i + 1}^{y} {d}_{i + 1}\end{matrix} ‖ \leq {k}_{max} {d}_{s}^{2} .$$

In one embodiment, if in a problem whose objective function minimizes Σᵢkᵢ² includes conditions:

$$‖ \begin{matrix}{x}_{i - 1} + {N}_{i - 1}^{x} {d}_{i - 1} - 2 ( {x}_{i} + {N}_{i}^{x} {d}_{i} ) + {x}_{i + 1} + {N}_{i + 1}^{x} {d}_{i + 1} \\ {y}_{i - 1} + {N}_{i - 1}^{y} {d}_{i - 1} - 2 ( {y}_{i} + {N}_{i}^{y} {d}_{i} ) + {y}_{i + 1} + {N}_{i + 1}^{y} {d}_{i + 1}\end{matrix} ‖ \leq {k}_{i} {d}_{s}^{2}$$

$$0 < {k}_{i} < {k}_{max}$$

then straightening of trajectories is enforced, i.e. ∥r⁽ⁱ⁾^{ⁿ}(0)∥.

In one embodiment, second order cone programming (SOCP) path planning with path straightening is formulated as follows:

$$min β ‖ k ‖ - {\sum }_{i} {d}_{i}$$

$$α \overline{d} \leq {d}_{i} ‖ {N}_{i} ‖ \leq \overline{d}$$

$$‖ \begin{matrix}{x}_{i - 1} + {N}_{i - 1}^{x} {d}_{i - 1} - 2 ( {x}_{i} + {N}_{i}^{x} {d}_{i} ) + {x}_{i + 1} + {N}_{i + 1}^{x} {d}_{i + 1} \\ {y}_{i - 1} + {N}_{i - 1}^{y} {d}_{i - 1} - 2 ( {y}_{i} + {N}_{i}^{y} {d}_{i} ) + {y}_{i + 1} + {N}_{i + 1}^{y} {d}_{i + 1}\end{matrix} ‖ \leq {k}_{i} {d}_{s}^{2}$$

$$0 < {k}_{i} < {k}_{max}$$

$$k = ( {k}_{1} , {k}_{2} , … , {k}_{n} )$$

i=1, 2, . . . ,n. where β is a weighting coefficient that determines the rate of straightening of trajectories when passing from row to row. If β=0 no straightening is assumed, only the averaged overlap is intended to be minimized.

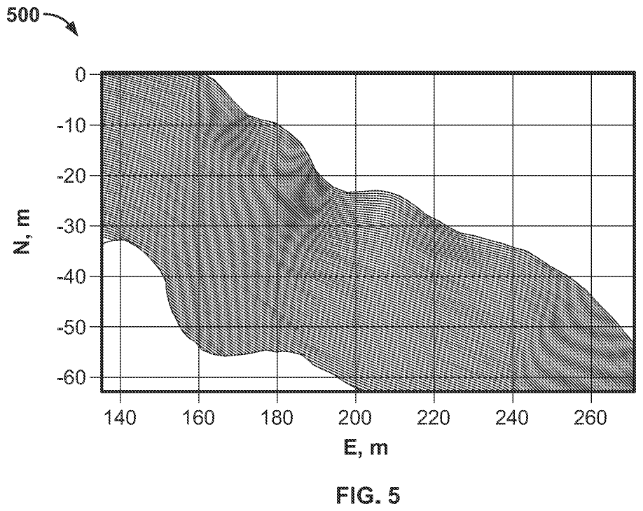

FIG. 5 shows a chart 500 illustrating a rate of straightening of trajectories when passing from row to row using the calculations directly above.

In one embodiment, a more accurate estimate can be calculated by accounting for the actual value ∥r⁽ⁱ⁾′(0)∥² Let dᵢ=1−qᵢ, i=1, 2, . . . ,n.

$$4 {‖ {r}^{{( i )}^{′}} ( 0 ) ‖}^{2} = {( {x}_{i + 1} + {N}_{i + 1}^{x} {d}_{i + 1} - {x}_{i - 1} - {N}_{i - 1}^{x} {d}_{i - 1} )}^{2} + {( {y}_{i + 1} + {N}_{i + 1}^{y} {d}_{i + 1} - {y}_{i - 1} - {N}_{i - 1}^{y} {d}_{i - 1} )}^{2} == {( {x}_{i + 1} + {N}_{i + 1}^{x} ( 1 - {q}_{i + 1} ) - {x}_{i - 1} - {N}_{i - 1}^{x} ( 1 - {q}_{i - 1} ) )}^{2} + {( {y}_{i + 1} + {N}_{i + 1}^{y} ( 1 - {q}_{i + 1} ) - {y}_{i - 1} - {N}_{i - 1}^{y} ( 1 - {q}_{i - 1} ) )}^{2} == {( {x}_{i + 1} + {N}_{i + 1}^{x} - {x}_{i - 1} - {N}_{i - 1}^{x} )}^{2} + 2 ( {x}_{i + 1} + {N}_{i + 1}^{x} - {x}_{i - 1} - {N}_{i - 1}^{x} ) ( {N}_{i - 1}^{x} {q}_{i - 1} - {N}_{i + 1}^{x} {q}_{i + 1} ) + {( {N}_{i - 1}^{x} {q}_{i - 1} - {N}_{i + 1}^{x} {q}_{i + 1} )}^{2} ++ {( {y}_{i + 1} + {N}_{i + 1}^{y} - {y}_{i - 1} - {N}_{i - 1}^{y} )}^{2} + 2 ( {y}_{i + 1} + {N}_{i + 1}^{y} - {y}_{i - 1} - {N}_{i - 1}^{y} ) ( {N}_{i - 1}^{y} {q}_{i - 1} - {N}_{i + 1}^{y} {q}_{i + 1} ) + {( {N}_{i - 1}^{y} {q}_{i - 1} - {N}_{i + 1}^{y} {q}_{i + 1} )}^{2} \\ {( {N}_{i - 1}^{x} {q}_{i - 1} - {N}_{i + 1}^{x} {q}_{i + 1} )}^{2} = {( {N}_{i - 1}^{x} {q}_{i - 1} )}^{2} + 2 {N}_{i - 1}^{x} {N}_{i + 1}^{x} {q}_{i - 1} {q}_{+ 1} + {( {N}_{i - 1}^{x} {q}_{i - 1} )}^{2}$$

All terms but (Nᵢ₋₁^{x}qᵢ₋₁−Nᵢ₊₁^{x}qᵢ₊₁)² and (Nᵢ₋₁^{y}qᵢ₋₁−Nᵢ₊₁^{y}qᵢ₊₁)² are linearly dependent on their variables and allow for formulation of SOCP.

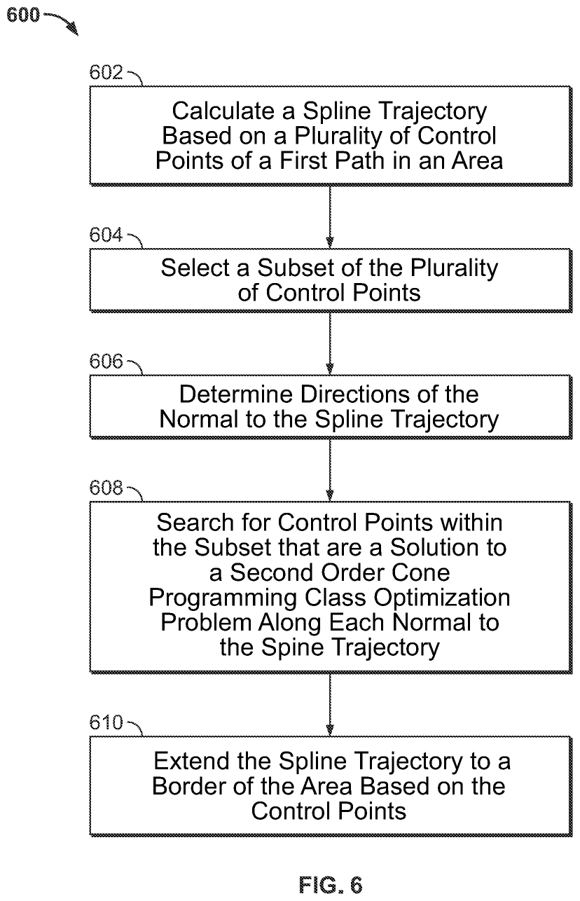

FIG. 6 depicts a flow chart 600 of a method for path planning according to an embodiment. The method can be performed by a device in advance of a machine following a generated path or the path can be generated simultaneously as the machine is traversing an area such as a field (e.g., planning a path for the machine to traverse in real-time). The device can be a stand-alone device used only for path planning or an existing device associated with the machine, such as a machine controller. For example, the method can be performed on a personal computer (e.g., located remote from the machine) or an onboard real-time industrial computer can be used. If the personal computer is used, the paths can be generated in advance. If the onboard real-time industrial computer is used, the paths can be generated in real time one by one. In one embodiment, the method starts at step 602 in which a spline trajectory is calculated based on a plurality of control points of a first path in an area. In one embodiment, the first path is identified by an azimuth and a point in the area. In one embodiment, the first path is a section of an area boundary of the area. At step 604 a subset of the plurality of control points having an equal step is selected. In one embodiment, the equal step is based on a Euclidian metric. At step 606 a direction of the normal to the spline trajectory for each of the selected points is determined. At step 608, control points within the subset that are a solution to a second order cone programming class optimization problem along each normal to the spine trajectory are searched for. At step 610 the spline trajectory is extended to a border of the area to create a second path adjacent to the first path based on the control points. The optimization problem can be used to minimize the average curvature at junction points of elementary sections of the spline trajectory and minimizes the average width overlap of adjacent paths. In one embodiment, the optimization problem uses an upper bound of a curvature constraint. The curvature constraint can be based on a maximum steering angle of a machine to follow a planned path.

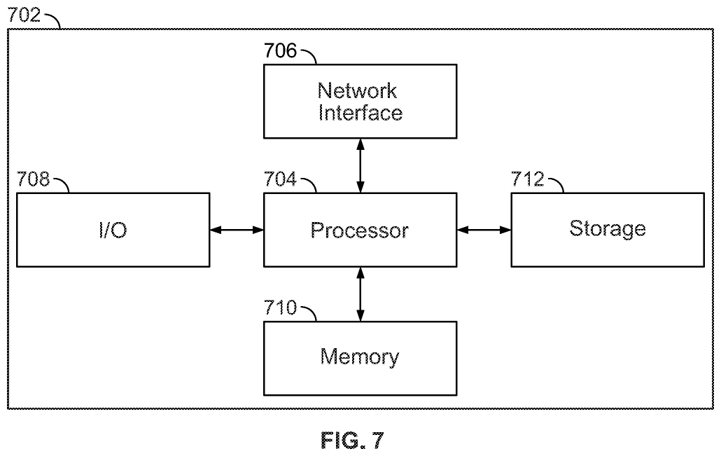

The methods, calculations, and operations described herein can be performed on a computer. A high-level block diagram of such a computer is illustrated in FIG. 7. Computer 702 contains a processor 704 which controls the overall operation of the computer 702 by executing computer program instructions which define such operation. The computer program instructions may be stored in a storage device 712, or other computer readable medium (e.g., magnetic disk, CD ROM, etc.), and loaded into memory 710 when execution of the computer program instructions is desired. Thus, the method steps of FIG. 6 can be defined by the computer program instructions stored in the memory 710 and/or storage 712 and controlled by the processor 704 executing the computer program instructions. For example, the computer program instructions can be implemented as computer executable code programmed by one skilled in the art to perform an algorithm defined by the method steps of FIG. 6. Accordingly, by executing the computer program instructions, the processor 704 executes an algorithm defined by the method steps of FIG. 6. The computer 702 also includes one or more network interfaces 706 for communicating with other devices via a network. The computer 702 also includes input/output devices 708 that enable user interaction with the computer 702 (e.g., display, keyboard, mouse, speakers, buttons, etc.) One skilled in the art will recognize that an implementation of an actual computer could contain other components as well, and that FIG. 7 is a high-level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for path planning comprising:
calculating a spline trajectory based on a plurality of control points of a first path in an area;
selecting a subset of the plurality of control points having an equal step;
determining a direction of the normal to the spline trajectory for each of the selected points;
searching for control points within the subset that are a solution to a second order cone programming class optimization problem along each normal to the spline trajectory; and
extending the spline trajectory to a border of the area to create a second path adjacent to the first path based on the control points.

2. The method of claim 1, wherein the optimization problem minimizes weighted sum of the average curvature at junction points of elementary sections of the spline trajectory.

3. The method of claim 1, wherein the equal step is based on a Euclidean metric.

4. The method of claim 1, wherein the optimization problem comprises an upper bound of a curvature constraint.

5. The method of claim 4, wherein the curvature constraint is based on a maximum steering angle of a machine.

6. The method of claim 1, wherein the first path is identified by an azimuth and a point in the area.

7. The method of claim 1, wherein the optimization problem also minimizes the average width overlap of adjacent paths.

8. An apparatus comprising:
a processor; and
a memory to store computer program instructions, the computer program instructions when executed on the processor cause the processor to perform operations comprising:
calculating a spline trajectory based on a plurality of control points of a first path in an area;
selecting a subset of the plurality of control points having an equal step;
determining a direction of the normal to the spline trajectory for each of the selected points;
searching for control points within the subset that are a solution to a second order cone programming class optimization problem along each normal to the spline trajectory; and
extending the spline trajectory to a border of the area to create a second path adjacent to the first path based on the control points.

9. The apparatus of claim 8, wherein the optimization problem minimizes the weighted sum of average curvature at junction points of elementary sections of the spline trajectory.

10. The apparatus of claim 8, wherein the equal step is based on a Euclidean metric.

11. The apparatus of claim 8, wherein the optimization problem comprises an upper bound of a curvature constraint.

12. The apparatus of claim 11, wherein the curvature constraint is based on a maximum steering angle of a machine.

13. The apparatus of claim 8, wherein the first path is identified by an azimuth and a point in the area.

14. The apparatus of claim 8, wherein the optimization problem also minimizes the average width overlap of adjacent paths.

15. A computer readable medium storing computer program instructions, which, when executed on a processor, cause the processor to perform operations comprising:
calculating a spline trajectory based on a plurality of control points of a first path in an area;
selecting a subset of the plurality of control points having an equal step;
determining a direction of the normal to the spline trajectory for each of the selected points;
searching for control points within the subset that are a solution to a second order cone programming class optimization problem along each normal to the spline trajectory; and
extending the spline trajectory to a border of the area to create a second path adjacent to the first path based on the control points.

16. The computer readable medium of claim 15, wherein the optimization problem minimizes the weighted sum of the average curvature at junction points of elementary sections of the spline trajectory.

17. The computer readable medium of claim 15, wherein the equal step is based on a Euclidean metric.

18. The computer readable medium of claim 15, wherein the optimization problem comprises an upper bound of a curvature constraint.

19. The computer readable medium of claim 18, wherein the curvature constraint is based on a maximum steering angle of a machine.

20. The computer readable medium of claim 15, wherein the first path is identified by an azimuth and a point in the area.

21. The computer readable medium of claim 15, wherein the optimization problem also minimizes the average width overlap of adjacent paths.
